(19) United States
(12) Patent Application Publication
(10) Pub. No.: US 2025/0284840 A1
(43) Pub. Date: Sep. 11, 2025

(54) TRANSPARENT AND FAST DATA REMEDIATION

(71) Applicant: Capital One Services, LLC, McLean, VA (US)

(72) Inventors: Joseph MERIAM, Frisco, TX (US); Sunita MAPADATH, The Colony, TX (US); Rahul NATH, Frisco, TX (US); Maxwell MURRAY, Dallas, TX (US)

(21) Appl. No.: 18/595,687

(22) Filed: Mar. 5, 2024

(51) Int. Cl. G06F 21/62

(52) U.S. Cl. CPC G06F 21/6245

(57) ABSTRACT

In some implementations, a remediation system may receive, a tracking system, a set of tickets associated with at least one data record. The remediation system may search, in the at least one data record and using a set of contexts indicated in the set of tickets, for a set of sensitive data snippets. The remediation system may generate a set of proposed remediations corresponding to the set of sensitive data snippets. The remediation system ma6y output, for each sensitive data snippet in the set of sensitive data snippets, a corresponding proposed remediation in the set of proposed remediations. The remediation system may selectively apply the set of proposed remediations based on inputs from a user.

### BACKGROUND

Sensitive fields may include personally identifiable information (PII), such as national identification numbers (e.g., social security numbers (SSNs) in the United States, social insurance numbers (SINs) in Canada, SSNs in the Philippines, permanent account numbers (PANs) in India, national insurance numbers (NINOs) in the United Kingdom, employer identification numbers (EINs) in the United States, individual taxpayer identification numbers (ITINs) in the United States, tax identification numbers (TINs) in Costa Rica, and/or other unique or quasi-unique identification numbers), credit card numbers, bank account numbers, passport numbers, and/or other PII. Data that includes sensitive fields should either be encrypted or should be masked when stored. For example, a masking system may replace sensitive fields with ‘X’s or other characters in order to prevent the sensitive fields from being stored.

### SUMMARY

Some implementations described herein relate to a system for data remediation. The system may include one or more memories and one or more processors communicatively coupled to the one or more memories. The one or more processors may be configured to receive, from a tracking system, a set of tickets associated with at least one data record. The one or more processors may be configured to search, in the at least one data record and using a set of contexts indicated in the set of tickets, for a set of sensitive data snippets. The one or more processors may be configured to generate a set of proposed remediations corresponding to the set of sensitive data snippets. The one or more processors may be configured to output, for each sensitive data snippet in the set of sensitive data snippets, a corresponding proposed remediation in the set of proposed remediations. The one or more processors may be configured to selectively apply the set of proposed remediations based on inputs from a user.

Some implementations described herein relate to a method of data remediation. The method may include receiving, at a remediation system and from a tracking system, a set of tickets associated with a plurality of data records. The method may include searching, in the plurality of data records and using a set of contexts indicated in the set of tickets, for a set of sensitive data snippets. The method may include determining, by the remediation system, that the set of sensitive data snippets are related. The method may include generating, by the remediation system, a single proposed remediation corresponding to the set of sensitive data snippets. The method may include outputting, from the remediating system and to a user, the single proposed remediation. The method may include selectively applying the single proposed remediation to the plurality of data records based on a single input from the user.

Some implementations described herein relate to a non-transitory computer-readable medium that stores a set of instructions for data remediation. The set of instructions, when executed by one or more processors of a device, may cause the device to receive, from a tracking system, a set of tickets associated with at least one data record. The set of instructions, when executed by one or more processors of the device, may cause the device to search, in the at least one data record and using a set of contexts indicated in the set of tickets, for a set of sensitive data snippets. The set of instructions, when executed by one or more processors of the device, may cause the device to generate a set of proposed remediations corresponding to the set of sensitive data snippets. The set of instructions, when executed by one or more processors of the device, may cause the device to selectively apply the set of proposed remediations based on inputs from a user. The set of instructions, when executed by one or more processors of the device, may cause the device to transmit, to the tracking system, a set of commands to clear the set of tickets based on selectively applying the set of proposed remediations.

### BRIEF DESCRIPTION OF THE DRAWINGS

FIGS. 1A-1C are diagrams of an example implementation relating to transparent and fast data remediation, in accordance with some embodiments of the present disclosure.

FIG. 2 is a diagram of an example implementation relating to grouping tickets for transparent and fast data remediation, in accordance with some embodiments of the present disclosure.

FIGS. 3A-3C are diagrams of example user interfaces (UIs) relating to transparent and fast data remediation, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIG. 6 is a flowchart of an example process relating to transparent and fast data remediation, in accordance with some embodiments of the present disclosure.

### DETAILED DESCRIPTION

The following detailed description of example implementations refers to the accompanying drawings. The same reference numbers in different drawings may identify the same or similar elements.

Sensitive fields, such as PII, should be masked before data that includes those sensitive fields is stored. For example, a system may use non-sensitive portions of the data such that the sensitive fields should be masked for security. Additionally, or alternatively, a system may lack sufficient encryption (e.g., according to legal rules, such as the Health Insurance Portability and Accountability Act (HIPAA), the General Data Protection Regulation (GDPR), and/or other laws and rules) such that the sensitive fields should be masked.

However, sensitive fields are not always masked before data is stored. Accordingly, monitoring systems may be deployed that scan stored data (e.g., periodically) and check for instances of unmasked sensitive data. However, in order to mask sensitive data detected in a data record in a remote storage, a user device generally downloads the whole data record, modifies the data record, and then re-writes the modified data record to the remote storage. This process increases network overhead and increases memory use at the user device.

Additionally, machine learning models may be deployed in order mask sensitive data detected by the monitoring systems. However, machine learning models generally operate as black boxes, and thus false positives from the monitoring systems may cause the machine learning models to propagate erroneous modifications to data records. Detecting and reversing such erroneous modifications costs significant computing resources at the remote storage.

Some implementations described herein enable output of proposed remediations for sensitive data snippets (e.g., as detected by a monitoring system). As a result, transparency is increased so that a user may reject false positives detected by the monitoring system. Additionally, computing resources are conserved that otherwise would have been spent on detecting and reversing erroneous modifications at a data source caused by the false positives. Some implementations described herein further enable the proposed remediations to be written directly to data records at the data source. As a result, network overhead is reduced, and memory use at a user device decreases, as compared with downloading whole data records, modifying the data records, and then re-writing the modified data records to the data source.

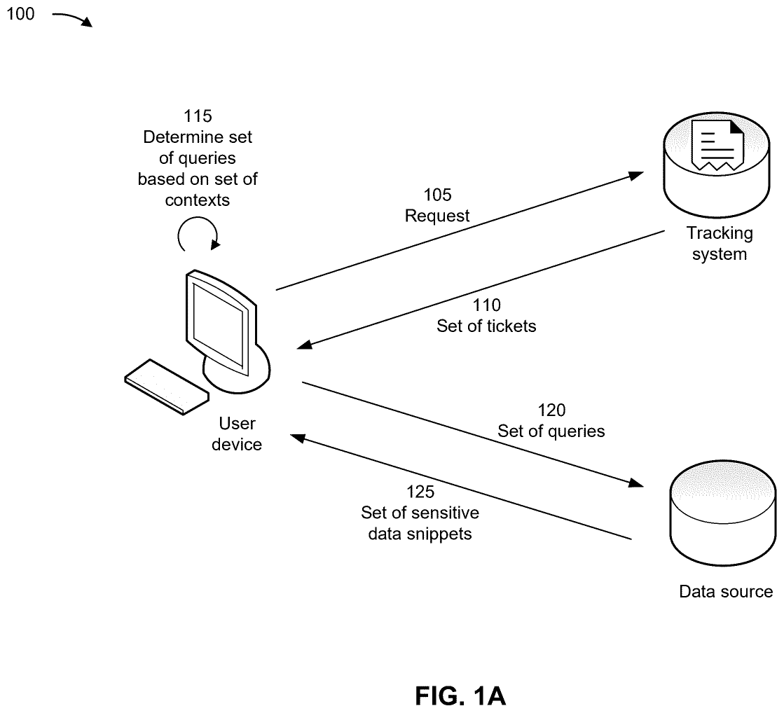

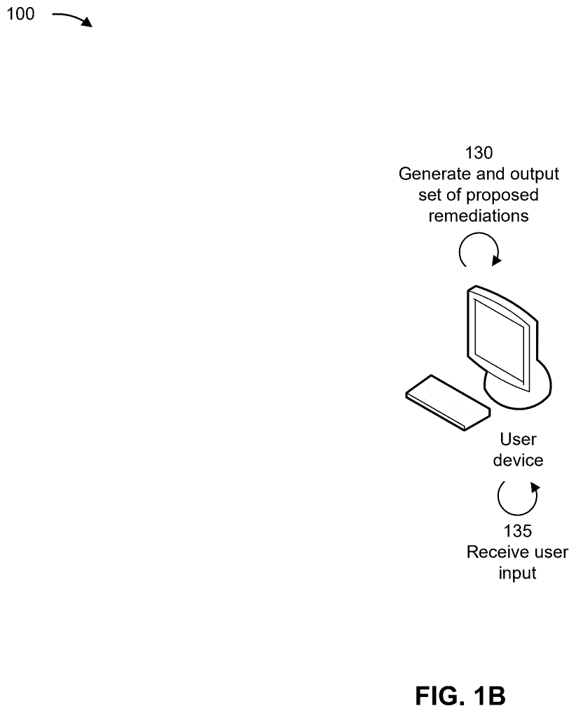

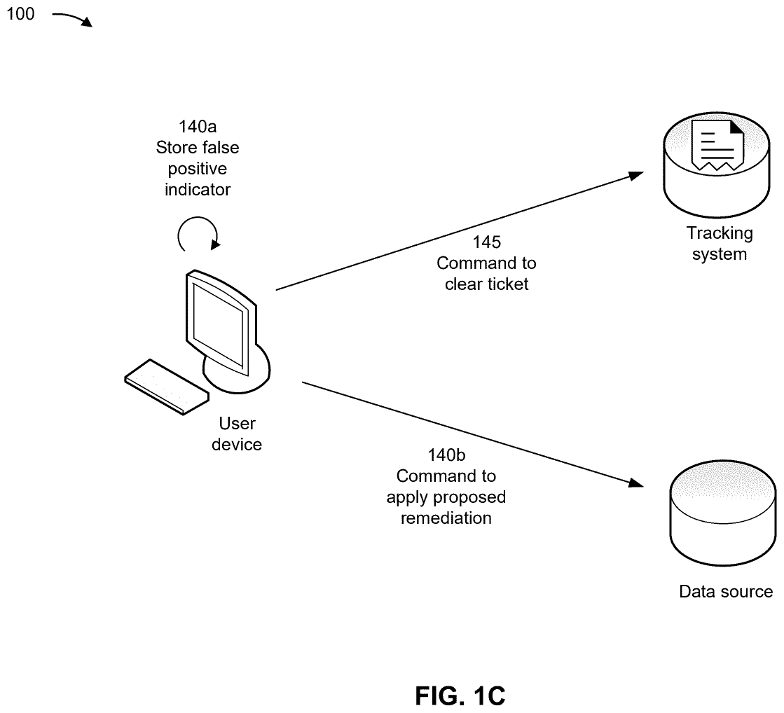

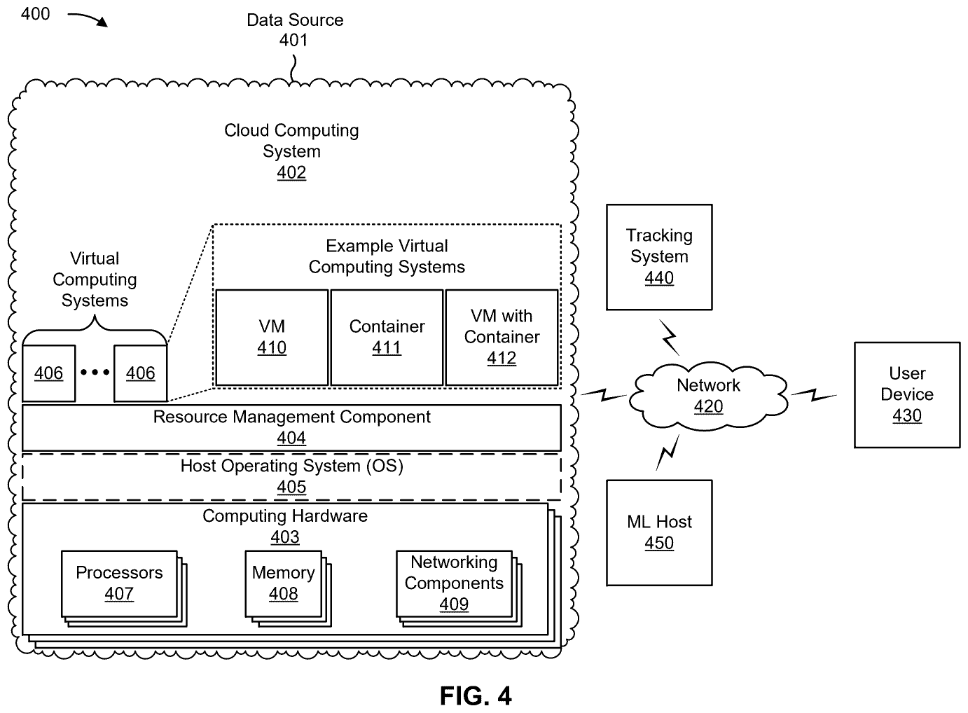

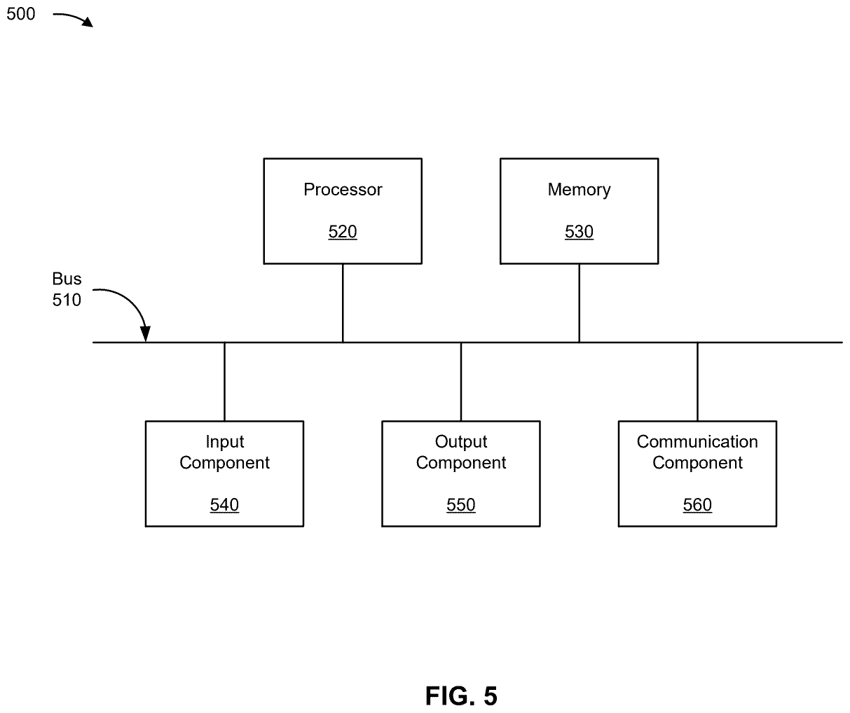

FIGS. 1A-1C are diagrams of an example 100 associated with transparent and fast data remediation. As shown in FIGS. 1A-1C, example 100 includes a user device, a tracking system, and a data source. These devices are described in more detail in connection with FIGS. 4 and 5.

As shown in FIG. 1A and by reference number 105, the user device may transmit, and the tracking system may receive, a request for a set of tickets. The request may include a hypertext transfer protocol (HTTP) request, a file transfer protocol (FTP) request, and/or a call to an application programming interface (API) function, among other examples. The request may include (e.g., in a header and/or as an argument) an identifier associated with a user (e.g., a username, an email address, and/or another type of alphanumeric identifier associated with the user). Accordingly, the tracking system may use the identifier to retrieve all tickets (or at least all tickets with an open or pending status) assigned to (or otherwise associated with) the user.

In some implementations, the request may include (e.g., in a header and/or as an argument) a set of credentials associated with the user. The set of credentials may include a username and password, a single sign-on (SSO) request, a certificate, a signature, a private key, and/or biometric information, among other examples. Therefore, the tracking system may process the request in response to verifying the set of credentials. Alternatively, the user device system may transmit the set of credentials in a separate message from the request, and the tracking system may receive (or otherwise accept) the request in response to verifying the set of credentials. The set of credentials may be received by the user device (e.g., from a storage controlled by the user device and/or provided to the user device by the user, such as via an input component of the user device).

As shown by reference number 110, the tracking system may transmit, and the user device may receive, the set of tickets. For example, the tracking system may transmit, and the user device may receive, the set of tickets in response to the request from the user device. The set of tickets may be associated with data records (e.g., at least one data record or a plurality of data records). The data records may be stored remotely from the user device (e.g., on the data source).

Additionally with, or alternatively to, receiving the set of tickets on demand (e.g., via a pull from the tracking system), the user device may receive the tickets periodically and/or as available (e.g., via a push from the tracking system). For example, the user device may subscribe to updates from the tracking system such that the tracking system transmits tickets periodically (e.g., according to a schedule) and/or in real time (or at least near real time) (e.g., as new tickets are created).

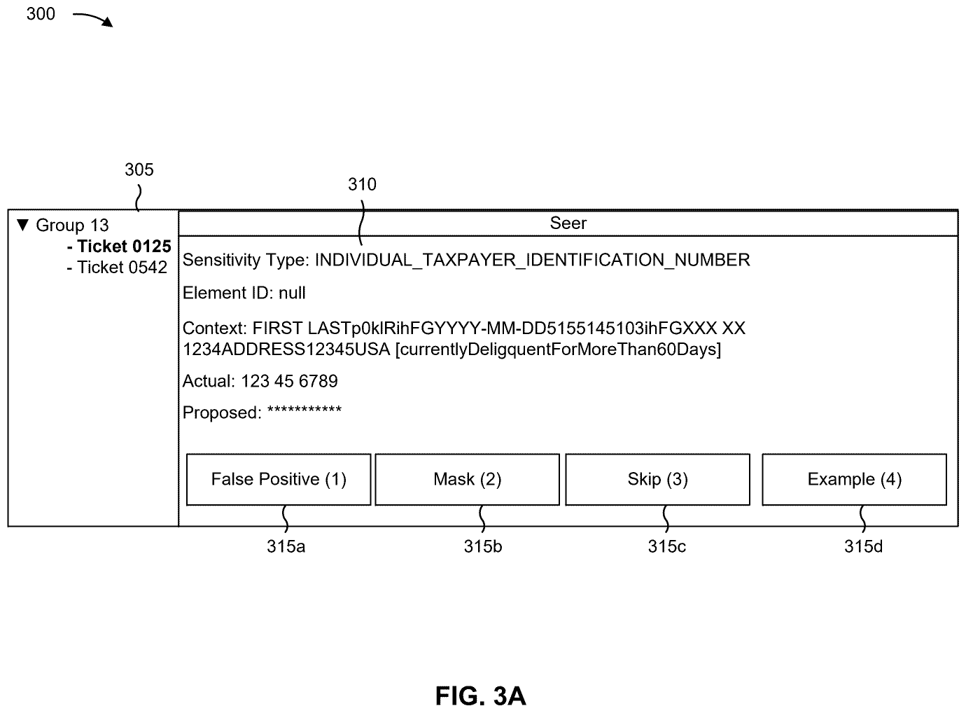

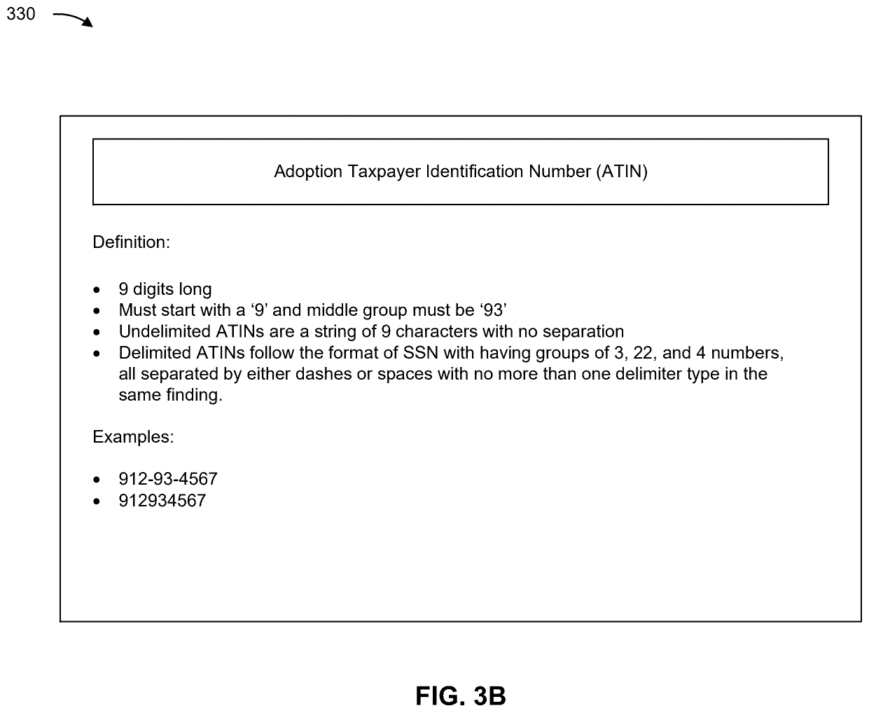

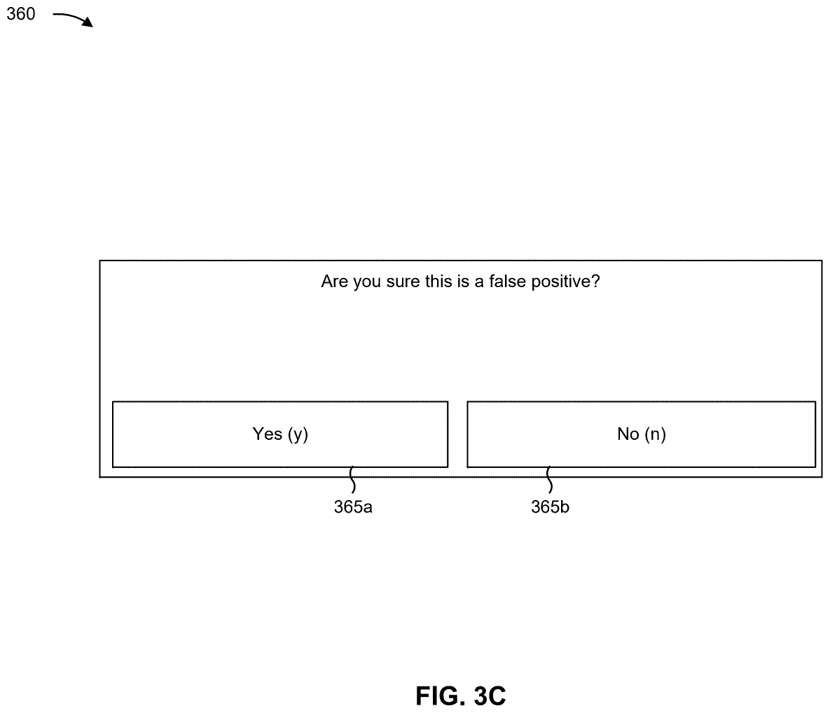

As shown by reference number 115, the user device may determine a set of queries based on a set of contexts indicated in the set of tickets. For example, a context may indicate data values surrounding a sensitive data snippet in a data record, a data type of the sensitive data snippet in the data record, data types surrounding the sensitive data snippet in the data record, and/or additional indicators of the sensitive data snippet without encoding the sensitive data snippet itself (an example of which is shown in FIG. 3A). Therefore, the user device may generate a query, corresponding to a context, that instructs a pull from the data record designed to include the sensitive data snippet. In some implementations, the query may pull the sensitive data snippet along with data values surrounding the sensitive data snippet. Therefore, the query may additionally indicate a pattern that the sensitive data snippet should match (e.g., 9##93####, 9##-93-####, or another similar pattern for adoption taxpayer identifier numbers (ATINs), as shown in FIG. 3B as an example). A database of patterns (e.g., stored in association with sensitive data types) may be stored locally at the user device or may be at least partially separate (e.g., logically, physically, and/or virtually) from the user device.

As shown by reference number 120, the user device may transmit, and the data source may receive, the set of queries. For example, the user device may perform a set of calls to an API function provided by the data source in order to transmit the set of queries. The data source may therefore execute the set of queries against the data records in order to obtain a set of sensitive data snippets (that are associated with the set of tickets) in the data records. Therefore, the user device may use the set of queries to search, in the data record and using the set of contexts, for the set of sensitive data snippets.

Although the example 100 is depicted with a single data sources, other examples may include a plurality of data sources. For example, the data records may be distributed across different data sources such that the user device transmits different queries to different data sources. In some implementations, each ticket may indicate one of the data sources (e.g., using a machine name, a hyperlink, and/or an Internet protocol (IP) address, among other examples), such that the user device transmits each query to the data source indicated in the ticket corresponding to the query.

As shown by reference number 125, the data source may transmit, and the user device may receive, the set of sensitive data snippets. In some implementations, the data source may return the set of set of sensitive data snippets directly. Alternatively, the data source may return a set of responses (to the set of queries), where each response includes a sensitive data snippet along with data values surrounding the sensitive data snippet. Accordingly, the user device may identify a set of data types corresponding to the set of tickets and may apply rules (e.g., one or more rules) associated with the set of data types to extract the set of sensitive data snippets from the set of responses. The rules may include patterns (e.g., one or more patterns), as described above, associated with the set of data types. Additionally, or alternatively, the user device may use a machine learning (ML) model to determine the set of sensitive data snippets. For example, the user device may provide the set of contexts to the ML model in order to receive the set of queries. Additionally, or alternatively, the user device may instruct the data source to apply the ML model, and the data source may receive an indication of the set of sensitive data snippets from the ML model (which the data source may forward to the user device). Additionally, or alternatively, the user device may provide the set of responses (from the data source) to the ML model in order to receive the sensitive data snippets.

The ML model may be trained (e.g., by an ML host and/or a device at least partially separate from the ML host) using a labeled set of data structures representing sensitive data (e.g., for supervised learning). The ML model may be configured to identify sensitive data snippets in data records. Additionally, or alternatively, the ML model may be trained using an unlabeled set of data structures representing sensitive data (e.g., for deep learning). The ML model may be configured to cluster contexts with other, related contexts in order to generate suggested identifications of sensitive data snippets (e.g., based on contexts being in a same cluster).

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., sensitive data). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the ML host, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm. Because the ML model is used to identify the set of sensitive data snippets but lacks permission to modify the data records, transparency is improved as compared with black box ML models that mask sensitive data automatically.

In some implementations, the set of sensitive data snippets are temporarily loaded in a memory (e.g., one or more memories) of the user device (e.g., after searching the data records). Therefore, the user device may refrain from receiving full copies of the data records. As a result, network overhead is reduced because the data source transmits less data to the user device. Additionally, memory use at the user device decreases because the user device refrains from caching (or otherwise storing) full copies of the data records.

As shown in FIG. 1B and by reference number 130, the user device may generate a set of proposed remediations corresponding to the set of sensitive data snippets. For example, the user device may map the set of sensitive data snippets to the set of proposed remediations based on data types of the sensitive data snippets. A database of proposed remediations (e.g., stored in association with sensitive data types) may be stored locally at the user device or may be at least partially separate (e.g., logically, physically, and/or virtually) from the user device.

As further shown by reference number 130, the user device may output the set of proposed remediations. For example, as shown in FIG. 3A, the user device may output a user interface (UI) that indicates a ticket (in the set of tickets) with an associated sensitive data snippet (in the set of sensitive data snippets) and a corresponding proposed remediation (in the set of proposed remediations). Therefore, the user of the user device may review the set of proposed remediations before the proposed remediations are applied. As a result, transparency is increased, and computing resources are conserved that otherwise would have been spent on detecting and reversing erroneous modifications at the data source caused by false positives.

As shown by reference number 135, the user device may receive a set of inputs from the user. For example, the user may interact (e.g., using an input component of the user device) with elements of UI that indicates the set of proposed remediations, as described in connection with FIG. 3A. The elements may include buttons that correspond to acceptances and rejections, as described below. As shown in FIG. 1C, the user device may selectively apply the set of proposed remediations based on the set of inputs from the user.

In some implementations, an input may include a rejection of a proposed remediation (e.g., at least one proposed remediation) in the set of proposed remediations. Therefore, as shown by reference number 140a, the user device may store a false positive indicator, associated with the proposed remediation, in response to the rejection. In implementations where the user device uses an ML model to search for (or otherwise identify) the set of sensitive data snippets, the user device may transmit a false positive indicator to an ML host (associated with the ML model) in response to the rejection. Accordingly, the ML host may re-train (and/or refine) the ML model based on the false positive indicator.

In some implementations, an input may include an acceptance of a proposed remediation (e.g., at least one proposed remediation) in the set of proposed remediations. Therefore, as shown by reference number 140b, the user device may transmit, and the data source may receive, a command (e.g., at least one command) to apply the proposed remediation in response to the acceptance. The command may include an HTTP message, an FTP message, and/or a call to an API function.

The operations described in connection with reference numbers 130, 135, 140a, and 140b may be iterative. For example, the user device may output each subsequent proposed remediation, in the set of proposed remediations, in sequence as the user reviews and either approves or rejects each previous proposed remediation. The user device may thus update the UI that in response to each acceptance and rejection. The user may provide input corresponding to each subsequent proposed remediation, and the user device may apply the subsequent proposed remediation (or store a false positive indicator) in response to each input.

As shown by reference number 145, the user device may transmit, and the tracking system may receive, a set of commands to clear the set of tickets based on selectively applying the set of proposed remediations. The set of commands may include a set of HTTP messages, a set of FTP messages, and/or a set of calls to an API function. By automatically clearing (or otherwise closing) the set of tickets, the user device conserves power and processing resources that otherwise would have been consumed in sorting and clearing the set of tickets after masking the set of sensitive data snippets.

Furthermore, the user device may remove set of sensitive data snippets from the memory of the user device after selectively applying the set of proposed remediations. As a result, the user device further reduces memory overhead after remediating the set of sensitive data snippets.

Although the example 100 is described in connection with the user device, other examples may include a remediation system that performs operations described in connection with the user device. The remediation system may include one or more devices capable of receiving, generating, storing, processing, and/or providing sensitive data snippets. The remediation system may include a communication device and/or a computing device. For example, the remediation system may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device.

By using techniques as described in connection with FIGS. 1A-1C, the user device may output the set of proposed remediations before applying the proposed remediations, which increases transparency and allows the user to reject false positives. Therefore, computing resources are conserved that otherwise would have been spent on detecting and reversing erroneous modifications at the data source caused by the false positives. Additionally, the user device may write proposed remediations (that are approved by the user) directly to the data records at the data source. As a result, network overhead is reduced, and memory use at the user device decreases, as compared with downloading full copies of the data records, modifying the data records, and then re-writing the modified data records to the data source.

As indicated above, FIGS. 1A-1C are provided as an example. Other examples may differ from what is described with regard to FIGS. 1A-1C.

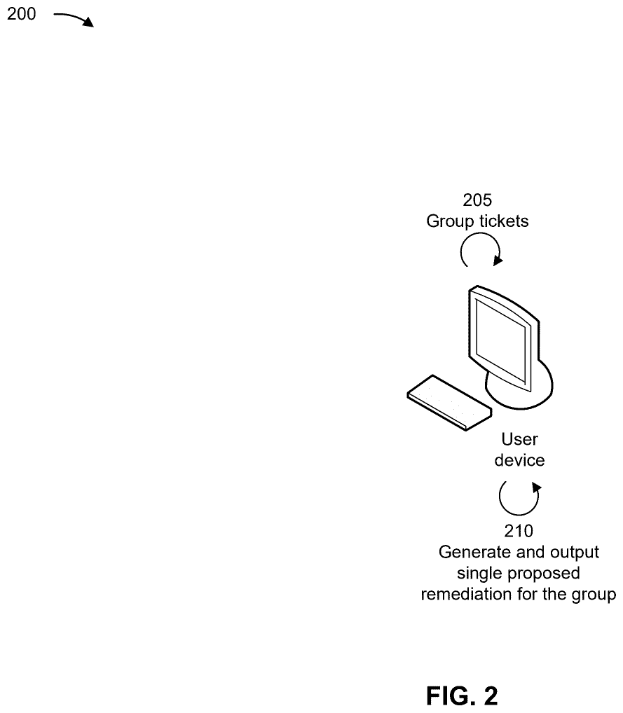

FIG. 2 is a diagram of an example 100 associated with grouping tickets for transparent and fast data remediation. As shown in FIG. 1, example 200 includes a user device, which is described in more detail in connection with FIGS. 4 and 5.

As described in connection with FIG. 1A, the user device may receive a set of tickets associated with a plurality of data records and may search, in the plurality of data records and using a set of contexts indicated in the set of tickets, for a set of sensitive data snippets. Additionally, as shown in FIG. 2 and by reference number 205, the user device may group the set of tickets. For example, the user device may determine that the set of sensitive data snippets are related. In one example, the user device may determine that one sensitive data snippet (in the set of sensitive data snippets) matches another sensitive data snippet (in the set of sensitive data snippets). A “match” may refer to a perfect match or a fuzzy match (e.g., matching within a margin of error and/or differing by an amount that satisfies a fuzzy match threshold, among other examples). Therefore, the user device may group the set of sensitive data snippets based on the sensitive data snippets matching. In another example, the user device may determine that a difference between one context (in the set of contexts) and another context (in the set of contexts) satisfies a similarity threshold. Therefore, the user device may group the set of sensitive data snippets based on a difference between contexts, associated with the set of sensitive data snippets, satisfying the similarity threshold.

As shown by reference number 210, the user device may generate a single proposed remediation corresponding to the set of sensitive data snippets. For example, the user device may map the set of sensitive data snippets to the single proposed remediation based on data types of the sensitive data snippets. A database of proposed remediations (e.g., stored in association with sensitive data types) may be stored locally at the user device or may be at least partially separate (e.g., logically, physically, and/or virtually) from the user device.

As further shown by reference number 210, the user device may output the single proposed remediation. For example, the user device may output a UI that indicates the set of tickets with the set of sensitive data snippets and the single proposed remediation. Therefore, the user of the user device may review the single proposed remediation and accept or reject the single proposed remediation (e.g., as described in connection with FIGS. 1B-1C).

Although the example 200 is described in connection with the user device, other examples may include a remediation system (e.g., as described above) that performs operations described in connection with the user device.

By using techniques as described in connection with FIG. 2, the user may remediate the set of sensitive data snippets with a single input rather than multiple inputs. As a result, the user device conserves additional power and processing resources by grouping the set of tickets.

As indicated above, FIG. 2 is provided as an example. Other examples may differ from what is described with regard to FIG. 2.

FIGS. 3A, 3B, and 3C are diagrams of example UIs 300, 330, and 360, respectively, associated with transparent and fast data remediation. The example UIs 300, 330, and/or 360 may be shown by a user device, which is described in more detail in connection with FIGS. 4 and 5.

As shown in FIG. 3A, the example UI 300 may include a panel 305 (or another visual portion of a window) that includes a list of tickets (e.g., from a set of tickets received as described in connection with FIG. 1A). In some implementations, as shown in FIG. 3A, the list of tickets may be included in a group (e.g., determined as described in connection with FIG. 2). The example UI 300 may further include a panel 310 (or another visual portion of a window) that indicates information from a ticket (e.g., including a data type and a context, as shown in FIG. 3A), a sensitive data snippet (e.g., from a data record, as described in connection with FIG. 1B), and a proposed remediation.

As further shown in FIG. 3A, the example UI 300 may include a button 315a (or another type of interactive element) that triggers the user device to reject the proposed remediation (e.g., as described in connection with FIG. 1C). The example UI 300 may further include a button 315b (or another type of interactive element) that triggers the user device to accept the proposed remediation (e.g., as described in connection with FIG. 1C). In some implementations, the example UI 300 may further include a button 315c (or another type of interactive element) that triggers the user device to skip the ticket (e.g., temporarily) and/or a button 315d (or another type of interactive element) that triggers the user device to output additional information associated with the data type (e.g., as described in connection with FIG. 3B).

As shown in FIG. 3B, the example UI 330 may include additional information associated with a data type. For example, the additional information may include a human-readable definition (and/or description) of the data type. Additionally, or alternatively, the additional information may include a pattern (or a set of patterns) associated with the data type.

As shown in FIG. 3C, the example UI 360 may be a confirmation screen associated with a rejection of a proposed remediation (e.g., output in response to a rejection of the proposed remediation). The example UI 360 may include a button 365a (or another type of interactive element) that triggers the user device to store (and/or transmit) a false positive indicator (e.g., as described in connection with FIG. 1C). The example UI 360 may further include a button 365b (or another type of interactive element) that triggers the user device to cancel the rejection of the proposed remediation.

As indicated above, FIGS. 3A-3C are provided as examples. Other examples may differ from what is described with regard to FIGS. 3A-3C. For example, the user device may output a confirmation screen, similarly as described in connection with FIG. 3C, associated with an acceptance of a proposed remediation.

FIG. 4 is a diagram of an example environment 400 in which systems and/or methods described herein may be implemented. As shown in FIG. 4, environment 400 may include a data source 401, which may include one or more elements of and/or may execute within a cloud computing system 402. The data source 401 may also be referred to as a “remote storage” herein. The cloud computing system 402 may include one or more elements 403-412, as described in more detail below. As further shown in FIG. 4, environment 400 may include a network 420, a user device 430, a tracking system 440, and/or an ML host 450. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the data source 401 may include one or more elements 403-412 of the cloud computing system 402, may execute within the cloud computing system 402, and/or may be hosted within the cloud computing system 402, in some implementations, the data source 401 may not be cloud-based (e.g., may be implemented outside of a cloud computing system) or may be partially cloud-based. For example, the data source 401 may include one or more devices that are not part of the cloud computing system 402, such as device 500 of FIG. 5, which may include a standalone server or another type of computing device. The data source 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The user device 430 may include one or more devices capable of receiving, generating, storing, processing, and/or providing information associated with sensitive data snippets, as described elsewhere herein. The user device 430 may include a communication device and/or a computing device. For example, the user device 430 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 430 may communicate with one or more other devices of environment 400, as described elsewhere herein.

The tracking system 440 may include one or more devices capable of receiving, generating, storing, processing, and/or providing information associated with tickets, as described elsewhere herein. The tracking system 440 may include a communication device and/or a computing device. For example, the tracking system 440 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The tracking system 440 may include an issue tracking system, such as Jira® or Bugzilla®, among other examples. The tracking system 440 may communicate with one or more other devices of environment 400, as described elsewhere herein.

The ML host 450 may include one or more devices capable of receiving, generating, storing, processing, and/or providing information associated with machine learning models, as described elsewhere herein. The ML host 450 may include a communication device and/or a computing device. For example, the ML host 450 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 450 may communicate with one or more other devices of environment 400, as described elsewhere herein.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with transparent and fast data remediation. The device 500 may correspond to a user device 430, a tracking system 440, and/or an ML host 450. In some implementations, a user device 430, a tracking system 440, and/or an ML host 450 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

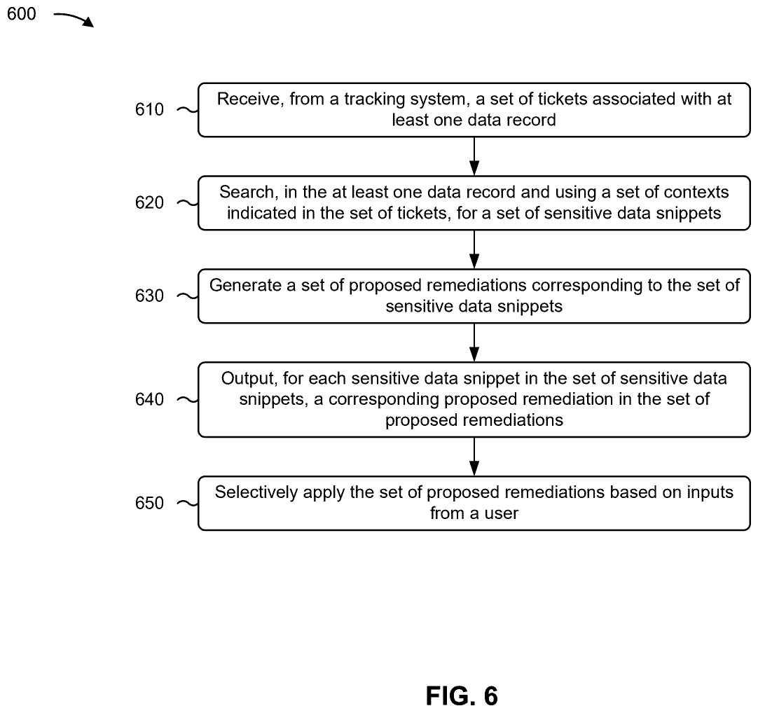

FIG. 6 is a flowchart of an example process 600 associated with transparent and fast data remediation. In some implementations, one or more process blocks of FIG. 6 may be performed by a user device 430. In some implementations, one or more process blocks of FIG. 6 may be performed by another device or a group of devices separate from or including the user device 430, such as a data source 401, a tracking system 440, and/or an ML host 450. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving, from a tracking system, a set of tickets associated with at least one data record (block 610). For example, the user device 430 (e.g., using processor 520, memory 530, and/or communication component 560) may receive, from a tracking system, a set of tickets associated with at least one data record, as described above in connection with reference number 110 of FIG. 1A. As an example, the user device 430 may receive the set of tickets in response to a request from the user device 430. The request may include an HTTP request, an FTP request, and/or a call to an API function, among other examples. The request may include (e.g., in a header and/or as an argument) an identifier associated with a user (e.g., a username, an email address, and/or another type of alphanumeric identifier associated with the user). Accordingly, the tracking system may use the identifier to retrieve all tickets (or at least all tickets with an open or pending status) assigned to (or otherwise associated with) the user.

As further shown in FIG. 6, process 600 may include searching, in the at least one data record and using a set of contexts indicated in the set of tickets, for a set of sensitive data snippets (block 620). For example, the user device 430 (e.g., using processor 520, memory 530, and/or communication component 560) may search, in the at least one data record and using a set of contexts indicated in the set of tickets, for a set of sensitive data snippets, as described above in connection with reference number 120 of FIG. 1A. As an example, the user device 430 may generate a set of queries, corresponding to the set of contexts, that instruct a set of pulls (from the at least one data record) designed to include the set of sensitive data snippets. In some implementations, the set of queries may pull the set of sensitive data snippets along with data values surrounding the set of sensitive data snippets. Therefore, the set of queries may additionally indicate a set of patterns that the set of sensitive data snippets should match. The user device 430 may perform a set of calls to an API function in order to transmit the set of queries. The user device 430 may therefore receive the set of sensitive data snippets (that are associated with the set of tickets) in response to the set of queries.

As further shown in FIG. 6, process 600 may include generating a set of proposed remediations corresponding to the set of sensitive data snippets (block 630). For example, the user device 430 (e.g., using processor 520 and/or memory 530) may generate a set of proposed remediations corresponding to the set of sensitive data snippets, as described above in connection with reference number 130 of FIG. 1B. As an example, the user device 430 may map the set of sensitive data snippets to the set of proposed remediations based on data types of the sensitive data snippets.

As further shown in FIG. 6, process 600 may include outputting, for each sensitive data snippet in the set of sensitive data snippets, a corresponding proposed remediation in the set of proposed remediations (block 640). For example, the user device 430 (e.g., using processor 520, memory 530, and/or output component 550) may output, for each sensitive data snippet in the set of sensitive data snippets, a corresponding proposed remediation in the set of proposed remediations, as described above in connection with reference number 130 of FIG. 1B. As an example and as shown in FIG. 3A, the user device 430 may output a UI that indicates a ticket (in the set of tickets) with an associated sensitive data snippet (in the set of sensitive data snippets) and the corresponding proposed remediation (in the set of proposed remediations).

As further shown in FIG. 6, process 600 may include selectively applying the set of proposed remediations based on inputs from a user (block 650). For example, the user device 430 (e.g., using processor 520 and/or memory 530) may selectively apply the set of proposed remediations based on inputs from a user, as described above in connection with FIG. 1C. As an example, the inputs may include a rejection of at least one proposed remediation, in the set of proposed remediations, and the user device 430 may store a false positive indicator, associated with the at least one proposed remediation, in response to the rejection. Additionally, or alternatively, the inputs may include an acceptance of at least one proposed remediation, in the set of proposed remediations, and the user device 430 may transmit at least one command to apply the at least one proposed remediation in response to the acceptance.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1C, FIG. 2, and/or FIGS. 3A-3C. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for data remediation, the system comprising:
one or more memories; and
one or more processors, communicatively coupled to the one or more memories, configured to:
receive, from a tracking system, a set of tickets associated with at least one data record;
search, in the at least one data record and using a set of contexts indicated in the set of tickets, for a set of sensitive data snippets;
generate a set of proposed remediations corresponding to the set of sensitive data snippets;
output, for each sensitive data snippet in the set of sensitive data snippets, a corresponding proposed remediation in the set of proposed remediations; and
selectively apply the set of proposed remediations based on inputs from a user.

2. The system of claim 1, wherein the set of sensitive data snippets are temporarily loaded in the one or more memories after searching and are removed from the one or more memories after selectively applying the set of proposed remediations.

3. The system of claim 2, wherein the at least one data record is stored remotely from the system.

4. The system of claim 1, wherein the one or more processors, to selectively apply the set of proposed remediations, are configured to:
receive, from the user, an acceptance of at least one proposed remediation in the set of proposed remediations; and
transmit at least one command, to a remote storage, to apply the at least one proposed remediation in response to the acceptance.

5. The system of claim 1, wherein the one or more processors, to selectively apply the set of proposed remediations, are configured to:
receive, from the user, a rejection of at least one proposed remediation in the set of proposed remediations; and
store a false positive indicator associated with the at least one proposed remediation in response to the rejection.

6. The system of claim 1, wherein the one or more processors, to search for the set of sensitive data snippets, are configured to:
identify a set of data types corresponding to the set of tickets; and
apply one or more rules associated with the set of data types to the at least one data record.

7. The system of claim 1, wherein the one or more processors, to search for the set of sensitive data snippets, are configured to:
provide the set of contexts to a machine learning model in order to receive an indication of the set of sensitive data snippets.

8. A method of data remediation, comprising:
receiving, at a remediation system and from a tracking system, a set of tickets associated with a plurality of data records;
searching, in the plurality of data records and using a set of contexts indicated in the set of tickets, for a set of sensitive data snippets;
determining, by the remediation system, that the set of sensitive data snippets are related;
generating, by the remediation system, a single proposed remediation corresponding to the set of sensitive data snippets;
outputting, from the remediating system and to a user, the single proposed remediation; and
selectively applying the single proposed remediation to the plurality of data records based on a single input from the user.

9. The method of claim Error! Reference source not found., further comprising:
transmitting, to the tracking system, a set of commands to clear the set of tickets based on selectively applying the single proposed remediation.

10. The method of claim Error! Reference source not found., wherein determining that the set of sensitive data snippets are related comprises:
determining, by the remediation system, that one sensitive data snippet, in the set of sensitive data snippets, matches another sensitive data snippet in the set of sensitive data snippets.

11. The method of claim Error! Reference source not found., wherein determining that the set of sensitive data snippets are related comprises:
determining, by the remediation system, that a difference between one context, in the set of contexts, and another context, in the set of contexts, satisfies a similarity threshold.

12. The method of claim Error! Reference source not found., wherein outputting the single proposed remediation comprises:
outputting instructions for a user interface (UI) including an indication of the single proposed remediation and an indication of at least one context in the set of contexts.

13. The method of claim 12, further comprising:
receiving the single input from the user based on interaction with the UI.

14. The method of claim Error! Reference source not found., further comprising:
receiving the set of sensitive data snippets from a data source and refraining from receiving full copies of the plurality of data records.

15. A non-transitory computer-readable medium storing a set of instructions for data remediation, the set of instructions comprising:
one or more instructions that, when executed by one or more processors of a device, cause the device to:
receive, from a tracking system, a set of tickets associated with at least one data record;
search, in the at least one data record and using a set of contexts indicated in the set of tickets, for a set of sensitive data snippets;
generate a set of proposed remediations corresponding to the set of sensitive data snippets;
selectively apply the set of proposed remediations based on inputs from a user; and
transmit, to the tracking system, a set of commands to clear the set of tickets based on selectively applying the set of proposed remediations.

16. The non-transitory computer-readable medium of claim Error! Reference source not found., wherein the one or more instructions, when executed by the one or more processors, further cause the device to:
receive the inputs from the user based on interaction with elements of a user interface that indicates the set of proposed remediations.

17. The non-transitory computer-readable medium of claim Error! Reference source not found., wherein the one or more instructions, that cause the device to search for the set of sensitive data snippets, cause the device to:
transmit, to a data source hosting the at least one data record, a set of queries based on the set of contexts; and
receive, from the data source, the set of sensitive data snippets in response to the set of queries.

18. The non-transitory computer-readable medium of claim Error! Reference source not found., wherein the one or more instructions, that cause the device to selectively apply the set of proposed remediations, cause the device to:
receive, from the user, a rejection of at least one proposed remediation in the set of proposed remediations; and
store a false positive indicator associated with the at least one proposed remediation in response to the rejection.

19. The non-transitory computer-readable medium of claim Error! Reference source not found., wherein the one or more instructions, that cause the device to selectively apply the set of proposed remediations, cause the device to:
receive, from the user, a rejection of at least one proposed remediation in the set of proposed remediations; and
transmit a false positive indicator to a machine learning host associated with searching for the set of sensitive data snippets.

20. The non-transitory computer-readable medium of claim Error! Reference source not found., wherein the one or more instructions, when executed by the one or more processors, further cause the device to:
receive a set of credentials associated with the user; and
transmit, to the tracking system, a request including the set of credentials,
wherein the set of tickets are received in response to the request.
